(19) United States
(12) Patent Application Publication
(10) Pub. No.: US 2004/0050005 A1
(43) Pub. Date: Mar. 18, 2004

(54) Reinforced fire retardant panel door

(76) Inventor: Enrico Autovino, Avenel, NJ (US)

Correspondence Address: EZRA SUTTON, P.A., PLAZA 9, 900 ROUTE 9, WOODBRIDGE, NJ, 07095, US

(21) Appl. No.: 10/247,726

(22) Filed: Sep. 13, 2002

(51) Int. Cl. E06B 3/70

(52) U.S. Cl. 52/455

(57) ABSTRACT

A reinforced fire retardant panel door that prevents buckling of the door during a fire. The reinforced fire retardant panel door includes a door member having at least one door panel and stiles and rails. The reinforced fire retardant panel door also includes at least four (4) steel washer inserts embedded within the door member for connecting at least one door panel to the stiles and rails. Further, the reinforced fire retardant panel door includes at least four (4) steel joint plates embedded within the door member for connecting said stiles and rails together more securely for providing increased structural strength and stiffness to the door in order to prevent buckling of the fire retardant panel door during a fire.

### FIELD OF INVENTION

The present invention relates to a fire retardant panel door, and more particularly to a reinforced fire retardant panel door that provides additional structural support, stiffness and fire resistance for preventing the spread of fire through the fire retardant panel door and door frame.

### BACKGROUND OF THE INVENTION

A fire retardant panel door, often referred to as a “fire door,” is installed in homes, commercial buildings, and industrial plants for preventing the passage or spread of fire from one part of the building to another. In the interest of public safety, standards have been set by governmental agencies; and by municipal, county and state building code authorities and insurance companies for the installation and performance of fire doors. The standards require that the fire retardant doors be installed in wall openings and that they pass industry-wide acceptance tests.

Standard test methods for fire door assemblies, such as ASTM E-152, UL 10(b) or NFPA 252, measure the ability of a door assembly to remain in an opening during a fire to retard the passage of the fire and evaluate the fire resistant properties of the door. In conducting such tests, doors are mounted in an opening of a fire proof wall. One side of the door is exposed to a predetermined range of temperatures over a predetermined period of time, followed by the application of a high pressure hose stream that causes the door to erode and provides a thermal shock to the assembly. Doors are given a fire rating based on the duration of the heat exposure of 20 minutes, 30 minutes, 45 minutes, one hour, 1½ hours or three hours. The door assembly receives the fire rating when it remains in the opening for the duration of the fire test and hose stream, within certain limitations of movement and without developing openings through the door either at the core or around the edge material.

A fire door must be made almost entirely of incombustible material. However, since a fire door is part of the interior or exterior of a personal living space or workspace, it must also be aesthetically pleasing. Usually, therefore, a core of incombustible material comprising the main structure of the fire door is overlaid with a thin wood veneer facing that provides the door with an attractive appearance. Fire door assemblies often fail, not because of the fire resistant properties of the fire door, but they fail because of inadequate structural strength of the door such that the fire door buckles. Additionally, the fire resistant blocking material of a core section of the fire door may need supplemental fire resistant materials strategically placed within the fire door to add to its fire door rating.

There remains a need for a reinforced fire retardant panel door which provides additional structural support, strength and stiffness to the fire retardant panel door in order to prevent buckling of the fire retardant panel door during a fire. Further, the reinforced fire retardant panel door would include supplemental fire resistant materials strategically embedded within the structural components of the fire retardant panel door.

### DESCRIPTION OF THE PRIOR ART

Fire retardant doors, and fire doors of various designs, configurations, structures and materials of construction have been disclosed in the prior art. For example, U.S. Pat. No. 6,115,976 to Gomez discloses an assembly for sealing a fire resistant door within a door frame during a fire event. The door edge assembly includes a plurality of door edges for receiving an intumescent strip within a slot on each door edge. The intumescent strip is constructed and designed to expand upon reaching a certain reaction temperature when exposed to a fire event or other extreme heat source. This prior art patent does not disclose or teach the particular door structure having steel insert washers and having steel joint plates for door reinforcement, nor the use of intumescent material in the door joints in order to provide for a reinforced fire retardant panel door that prevents buckling of the door during a fire, as well as prevent the spread of fire through the door and door frame for at least 90 minutes.

U.S. Pat. No. 5,816,017 to Hunt et al. discloses a fire retardant door and exit device for the fire retardant door. The fire retardant door includes a core of fire resistant blocking material being Tectonite™ for providing the door with a fire rating of at least 90 minutes. The fire door uses intumescent material which expands when heated to fill the void in the channel between the channel walls and the vertical extending rods within the latch stile of the door. This prior art patent does not disclose or teach the particular door structure having steel insert washers and having steel joint plates for door reinforcement, nor the use of intumescent material in the door joints in order to provide for a reinforced fire retardant panel door that prevents buckling of the door during a fire, as well as prevents the spread of fire through the door and door frame.

U.S. Pat. No. 5,417,024 to San Paolo discloses a fire resistant panel door. The fire resistant panel door is constructed from panels, stiles, mullion and rails having a core of fire resistant material. The door components are joined together so that the fire resistant material extends substantially continuously from side to side and from top to bottom of the finished door. The fire resistant core of each door panel is recessed within the fire resistant core of the associated rails and stiles to reduce air infiltration through the door which can compromise the door's fire resistance. This prior art patent does not disclose or teach the particular door structure having steel insert washers and having steel joint plates for door reinforcement, nor the use of intumescent material in the door joints in order to provide for a reinforced fire retardant panel door that prevents buckling of the door during a fire.

U.S. Pat. No. 4,930,276 to Bawa et al. discloses a fire door window construction. The fire door includes a trim strip having inner and outer members. The inner member is of a high density incombustible mineral material or ceramic and is nailed in position to securely and uniformly hold the pane of glass in the door opening. The outer trim member is of a fire retardant particle board and has an exposed wood veneer facing throughout. An intumescent caulking compound is applied between an inner portion of the outer trim member and the pane of glass. This prior art patent does not disclose or teach the particular door structure having steel insert washers and having steel joint plates for door reinforcement, nor the use of intumescent material in the door joints in order to provide for a reinforced fire retardant panel door that prevents buckling of the door during a fire, as well as prevents the spread of fire through the door and door frame for at least 90 minutes.

U.S. Pat. No. 4,441,296 to Grabendike et al. discloses a fire resistant wood door structure designed to pass code and testing laboratories' requirements. The fire resistant wood door structure includes a door assembly having a support frame assembly with a panel assembly connected to the support frame assembly. The support frame assembly includes top, bottom, side, central and transverse frame members. The panel members include a main body connected through a peripheral edge by a double connector assembly. The double connector assembly functions to only remove about ⅓ of the door's normal 1¾ inch thickness during the burn testing procedure, thus passing the fire resistant testing of 20 minutes. This prior art patent does not disclose or teach the particular door structure having steel insert washers and having steel joint plates for door reinforcement, nor the use of intumescent material in the door joints in order to provide for a reinforced fire retardant panel door that prevents buckling of the door during a fire, as well as prevents the spread of fire through the door and door frame for at least 90 minutes.

U.S. Pat. Nos. 4,529,742; 6,031,040; and 6,153,674 all disclose the use of intumescent compounds/fire barrier materials within door construction to reduce or eliminate the passage of smoke and fire through the door and door frame. These prior art patents do not disclose or teach the particular door structure having steel insert washers and having steel joint plates for door reinforcement, nor the use of intumescent material in the door joints in order to provide for a reinforced fire retardant panel door that prevents buckling of the door during a fire, as well as prevents the spread of fire through the door and door frame for at least 90 minutes.

In addition, the aforementioned prior art patents do not disclose or teach the particular structure and configuration of the reinforced fire retardant panel door of the present invention that provides additional structural support, strength and stiffness to the door in order to prevent the buckling of the door during a fire.

Accordingly, it is an object of the present invention to provide a reinforced fire retardant panel door that prevents buckling of the door during a fire.

Another object of the present invention is to provide a reinforced fire retardant panel door that has additional structural support, strength and stiffness with the use of a plurality of joint steel washers and a plurality of joint steel plates which are embedded within the fire resistant blocking material (core section) of the door for preventing the buckling of the fire door during a fire.

Another object of the present invention is to provide a reinforced fire retardant panel door that has supplemental fire resistant materials strategically embedded and placed within the tongue and groove joints of the fire resistant panel door, as well as supplemental fire resistant materials placed on the perimeter edges of the fire resistant panel door for preventing the spread of fire through the door and door frame.

Another object of the present invention is to provide a reinforced fire retardant panel door that has fire resistant materials being intumescent material that expands in the presence of fire such that the intumescent material closes and seals the component tongue and groove joints, as well as the perimeter edges of the fire retardant panel door for preventing the spread of fire through the door and door frame.

Another object of the present invention is to provide a reinforced fire retardant panel door that is used as part of an interior or exterior personal living space, or workspace being installed within home dwellings, commercial buildings or industrial plants.

Another object of the present invention is to provide a reinforced fire retardant panel door that is aesthetically pleasing having the appearance of natural wood, and has achieved a successful fire rating of at least 90 minutes and passes a positive pressure test, and is easily installed in a building.

A further object of the present invention is to provide a reinforced fire retardant panel door that can be mass produced in an automated and economical matter and is readily affordable to the builder or consumer.

### SUMMARY OF THE INVENTION

In accordance with the prevention, there is provided a reinforced fire retardant panel door that prevents buckling of the door during a fire. The reinforced fire retardant panel door includes a door having at least one door panel and stiles and rails. The reinforced fire retardant panel door also includes at least four (4) steel washer inserts embedded within the door for reinforcing the connection between the door panel and the stiles and rails. Further, the reinforced fire retardant panel door includes at least four (4) steel joint plates embedded within the door member for reinforcing the connection between the stiles and rails for providing increased structural strength and stiffness to the door in order to prevent buckling of the fire retardant panel door during a fire.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a front perspective view of the reinforced fire retardant panel door of the preferred embodiment of the present invention showing its major component parts thereof;

FIG. 2a is a cross-sectional view of the reinforced fire retardant panel door of the present invention taken along lines 2a-2a of FIG. 1 in the direction of the arrows showing a pair of joint plates connecting a stile to an upper rail and a lower rail and a joint washer;

FIG. 2b is a cross-sectional view of the reinforced fire retardant panel door of the present invention taken along lines 2b-2b of FIG. 1 in the direction of the arrows showing a pair of joint washers connecting the right panel to the upper rail and the lower rail, respectively;

FIG. 3a is a cross-sectional view of the reinforced fire retardant panel door of the present invention taken along lines 3a-3a of FIG. 1 in the direction of the arrows showing a pair of joint washers connecting the upper rail to a pair of panels;

FIG. 3b is a cross-sectional view of the reinforced fire retardant panel door of the present invention taken along lines 3b-3b of FIG. 1 in the direction of the arrows showing a plurality of joint washers being connected to opposing stiles, opposing panels and a center panel;

FIG. 4 is an enlarged sectional view of the reinforced fire retardant panel door of the present invention taken along lines 4-4 of FIG. 1 in the direction of the arrows showing the joint plate embedded into the core and held into place by screws for reinforcing a tongue and groove joint between the stile and rail; and

FIG. 5 is an enlarged sectional view of the reinforced fire retardant panel door of the present invention of FIG. 3b showing intumescent material embedded within the tongue and groove joint.

### DETAILED DESCRIPTION OF THE PREFERRED EMBODIMENT

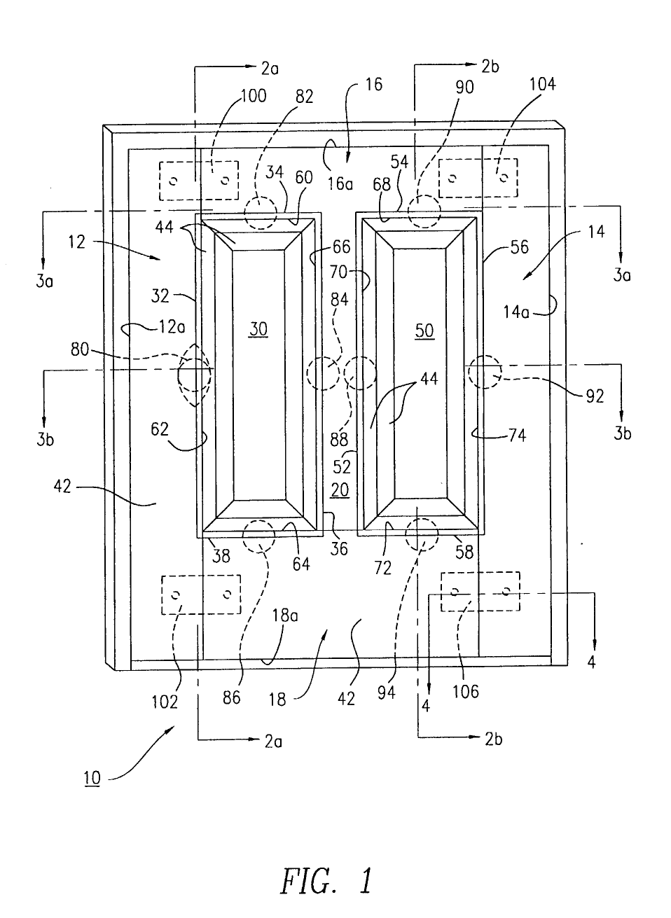

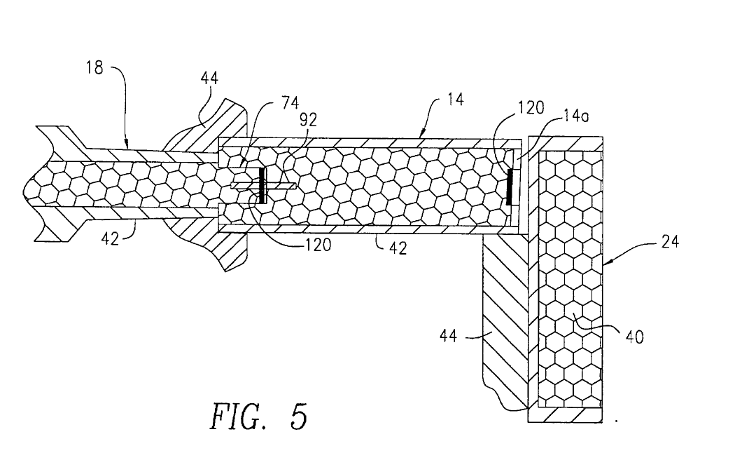

The reinforced fire retardant panel door 10 of the preferred embodiment of the present invention is represented in detail by FIGS. 1 through 5 of the patent drawings. The fire retardant panel door 10 is used to fireproof an area and to prevent fire from spreading to other areas within a home dwelling, commercial building or industrial plant.

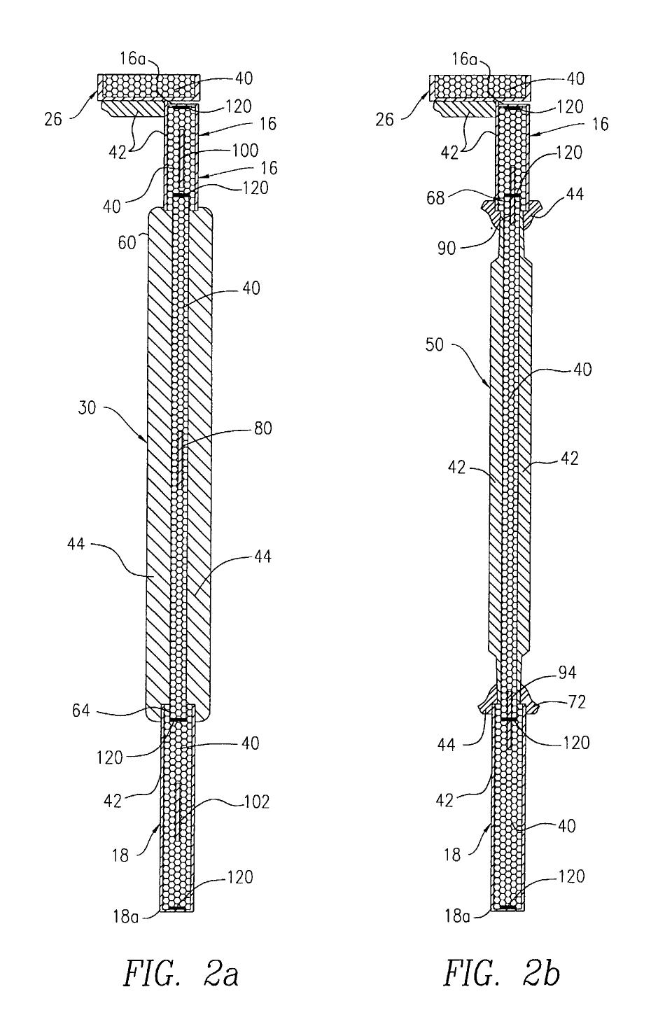

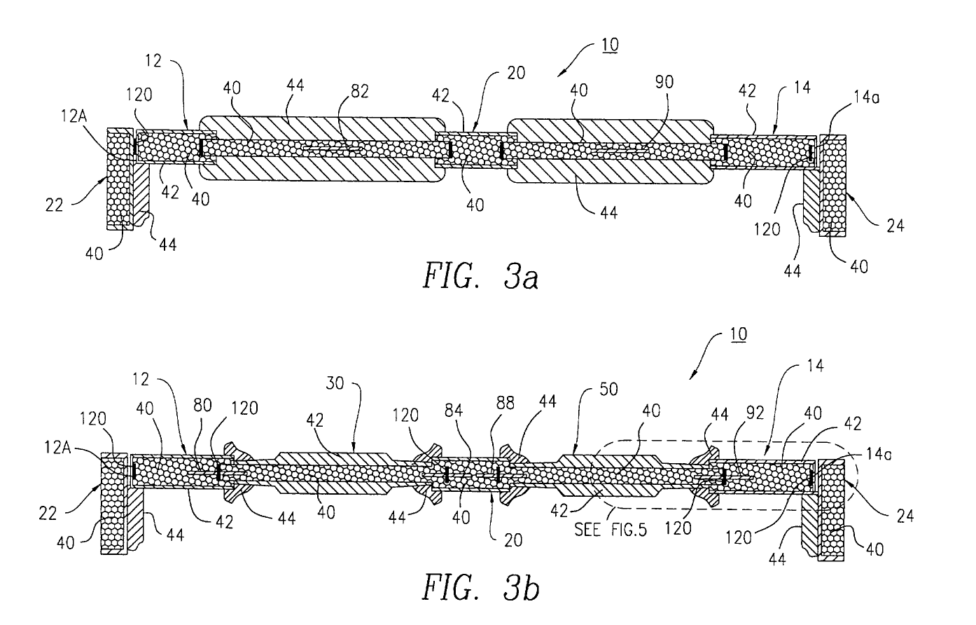

Fire retardant panel door 10 includes stiles 12 and 14, rails 16 and 18, a center panel 20, a first panel 30 and a second panel 50, as shown in FIGS. 1 to 4. The fire retardant panel door 10 is hingedly connected between a left or right door jamb 22 or 24 and positioned below an upper header 26, as depicted in FIGS. 2a and 3a. Panel 30 has edges 32, 34, 36 and 38 and panel 50 has edges 52, 54, 56 and 58. Stiles 12 and 14, rails 16 and 18, and panels 20, 30 and 50 have a core section 40 formed of Tectonite material. Wood applique 42 and molding 44 are applied to the exterior surface of stiles 12 and 14, rails 16 and 18, and panels 20, 30 and 50, as shown in FIGS. 1, 2a, 2b, 3a and 3b of the drawings.

Tongue and groove joints 60 and 62 are used to connect panel 30 to the door 10, and tongue and groove joints 64 and 66 are used to connect panel 30 to the door 10. Tongue and groove joints 68 and 70 are used to connect panel 50 to the door 10, and tongue and groove joints 72 and 74 are used to connect panel 50 to the door 10. To reinforce the tongue and groove joints 60, 62, 64, 66, 68, 70, 72 and 74, the present invention employs eight (8) steel joint washers 80, 82, 84, 86, 88, 90, 92 and 94 that are 2½ inches in diameter and ⅛ inch thick. As shown in FIGS. 1, 2a, 2b, 3a and 3b, the eight (8) joint washers reinforce the joints between the panels 30 and 50, and the stiles 12 and 14, the rails 16 and 18, and the center panel 20. One of the steel joint washers 80 to 94 is placed on each of the four (4) edges 32 to 38 and 52 to 58 of panels 30 and 50, respectively. Each of the joint washers 80 to 94 is embedded within the core section 40 of the stiles 12, 14, the rails 16, 18, center panel 20 and the panels 30, 50, as shown in FIGS. 2a, 2b, 3a and 3b. The joint washers 80 to 94 can be made of metal materials, such as steel, stainless steel alloys, tantalum and titanium alloys. Additional washers may be employed for additional strength, if desired.

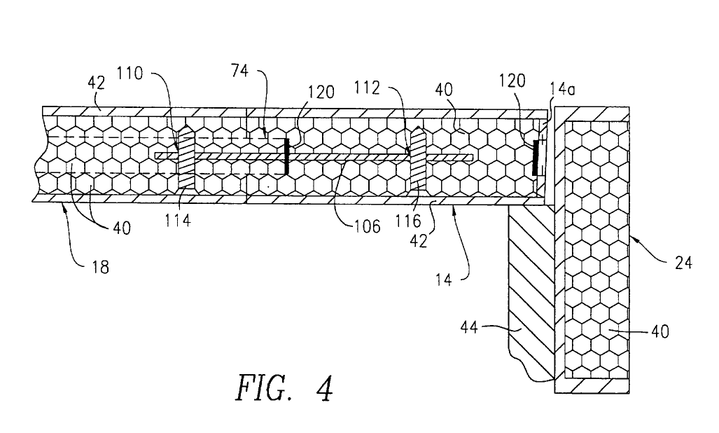

To reinforce the connection between the stiles 12 and 14 and the rails 16 and 18, the present invention employs four (4) joint plates 100, 102, 104 and 106 that are each 3 inches by 6 inches, and ⅛ inch thick. Preferably, they are rectangular in shape and each have two (2) screw hole openings 110 and 112 for receiving screws 114 and 116 to hold the joint plates 100 to 106 in place, as shown in FIGS. 1, 2 and 4 of the patent drawings. Each of the joint plates are embedded within the core section 40 of the stiles 12, 14 and the rails 16, 18, as shown in FIGS. 2a and 4 of the drawings. The joint plates 100 to 106 can be made of metal materials, such as steel, stainless steel alloys, tantalum and titanium alloys.

To further reinforce door 10, intumescent material 120 is embedded in each of the tongue and groove joints 60 to 74, and is also applied to outer perimeter edges 12a, 14a, 16a, 18a of the stiles 12, 14 and the rails 16, 18, respectively, as shown in FIGS. 1 to 4 of the drawings. The intumescent material 120 expands in the presence of excessive heat and/or fire such that the intumescent material 120 closes and seals each of the tongue and groove points 60 to 74 to prevent the spread of the excessive heat and/or fire through the fire retardant panel door 10. Additionally, the intumescent material 120 on the outer perimeter edges 12a, 14a, 16a and 18a of the stiles and rails 12, 14, 16 and 18, respectively, also expands in the presence of excessive heat and/or fire such that the intumescent material 120 closes and seals the perimeter of the fire retardant panel door 10 within the jambs 22, 24 and header 26 of the door frame (not shown) to also prevent the spread of the excessive heat and/or fire through the fire retardant panel door 10 and door frame.

The core section 40 is made from Tectonite™ material which is manufactured by and is available from Warm Springs Composite Products Company of Warm Springs, Oreg. of the United States. The core section 40 is a fire resistant, insulative composite blocking material suitable for use in door 10 of the present invention. The Tectonite™ material has a fire rating above 90 minutes and is used for the core section 40 as a single component construction. The core section (blocking material) 40, the joint washers 80 to 94, and the joint plates 102 to 106 all provide structural support, strength and stiffness to the door 10 construction. It is understood that the core (blocking material) section 40 can be made of any fire resistant blocking material approved for fire door applications which has a proven fire door rating.

In operation, when fire or excessive heat occurs, the intumescent material 120 expands and provides closing and sealing of all the tongue and groove joints 60 to 74 and also provides closing and sealing of the perimeter of the fire retardant panel door 10 within its door frame (not shown), thus preventing the spread of the fire through the fire retardant panel door. Further, the core section 40, the steel joint washers 80 to 94, and the steel joint plates 100 to 106 in combination with each other, all cooperate to provide additional structural support, strength and stiffness to the door 10 construction, thus preventing the door 10 from buckling in the presence of excessive heat and/or fire.

### ADVANTAGES OF THE PRESENT INVENTION

Accordingly, it is an advantage of the present invention that it provides for a reinforced fire retardant panel door that prevents buckling of the door during a fire.

Another advantage of the present invention is that it provides for a reinforced fire retardant panel door that has additional structural support, strength and stiffness with the use of a plurality of joint steel washers and a plurality of joint steel plates which are embedded within the fire resistant blocking material (core section) of the door for preventing the buckling of the fire door during a fire.

Another advantage of the present invention is that it provides for a reinforced fire retardant panel door that has supplemental fire resistant materials strategically embedded and placed within the tongue and groove joints of the fire resistant panel door, as well as supplemental fire resistant materials placed on the perimeter edges of the fire resistant panel door for preventing the spread of fire through the door and door frame.

Another advantage of the present invention is that it provides for a reinforced fire retardant panel door that has fire resistant materials being intumescent material that expands in the presence of fire such that the intumescent material closes and seals the component tongue and groove joints, as well as the perimeter edges of the fire retardant panel door for preventing the spread of fire through the door and door frame.

Another advantage of the present invention is that it provides for a reinforced fire retardant panel door that is used as part of an interior or exterior personal living space, or workspace being installed within home dwellings, commercial buildings or industrial plants.

Another advantage of the present invention is that it provides for a reinforced fire retardant panel door that is aesthetically pleasing having the appearance of natural wood, and has achieved a successful fire rating of at least 90 minutes and passes a positive pressure test, and is easily installed in a building.

A further advantage of the present invention is that it provides for a reinforced fire retardant panel door that can be mass produced in an automated and economical matter and is readily affordable to the builder or consumer.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A reinforced fire retardant panel door, comprising:
a) a door having at least one door panel and stiles and rails;
b) at least four (4) metal inserts embedded within said door for reinforcing the connection between said at least one door panel and said stiles and rails; and
c) at least four (4) metal joint plates embedded within said door for reinforcing the connection between said stiles and rails for providing increased structural strength to said door in order to prevent buckling of said door during a fire.

2. A reinforced fire retardant panel door in accordance with claim 1, wherein said at least one door panel being connected to said door by joints, and said joints having intumescent material in said joints which expands upon exposure to heat and/or fire to seal said joints in order to prevent the heat and/or fire from passing through said door during a fire.

3. A reinforced fire retardant panel door in accordance with claim 2, wherein said door includes perimeter edging having said intumescent material thereon which expands upon exposure to heat and/or fire to seal said perimeter edging relative to a door frame in order to prevent the heat and/or fire from passing through said door and door frame during a fire.

4. A reinforced fire retardant panel door in accordance with claim 2, wherein said metal inserts are embedded within said joints for reinforcing the connection between said at least one door panel and said stiles and rails.

5. A reinforced fire retardant panel door in accordance with claim 2, wherein said stiles and rails being connected to each other by said joints, and wherein said metal joint plates are embedded within said joints for reinforcing the connection between said stiles and rails.

6. A reinforced fire retardant panel door in accordance with claim 2, wherein said joints are tongue and groove joints.

7. A reinforced fire retardant panel door in accordance with claim 1, wherein said metal inserts are embedded within a core section of said door.

8. A reinforced fire retardant panel door in accordance with claim 7, wherein said metal joint plates are embedded within said core section of said door.

9. A reinforced fire retardant panel door in accordance with claim 8, wherein said core section is made from a fire resistant blocking material.

10. A reinforced fire retardant panel door in accordance with claim 9, wherein said core section in combination with said embedded metal inserts and said embedded metal joint plates increases the structural strength of said door in order to prevent buckling of said door during a fire.

11. A reinforced fire retardant panel door in accordance with claim 1, wherein said metal inserts are made from a metal material selected from the group consisting of steel, stainless steel alloys, tantalum, and titanium alloys.

12. A reinforced fire retardant panel door in accordance with claim 1, wherein said metal joint plates are made from a metal material selected from the group consisting of steel, stainless steel alloys, tantalum, and titanium alloys.

13. A reinforced fire retardant panel door, comprising:
a) a door having at least two door panels and stiles and rails;
b) at least four (4) metal inserts embedded within said door for reinforcing the connection between each of said door panels and said stiles and rails;
c) at least four (4) metal joint plates embedded within said door for reinforcing the connection between said stiles and rails for providing increased structural strength to said door in order to prevent buckling of said door during a fire; and
d) said panels being connected to said door by joints, and said joints having intumescent material in said joints which expands upon exposure to heat and/or fire to seal said joints in order to prevent the heat and/or fire from passing through said door during a fire.

14. A reinforced fire retardant panel door in accordance with claim 13, wherein said door includes perimeter edging having said intumescent material thereon which expands upon exposure to heat and/or fire to seal said perimeter edging relative to a door frame in order to prevent the heat and/or fire from passing through said door and door frame during a fire.

15. A reinforced fire retardant panel door in accordance with claim 13, wherein said metal inserts are embedded within said joints for reinforcing the connection between said at least two door panels and said stiles and rails.

16. A reinforced fire retardant panel door in accordance with claim 13, wherein said stiles and rails being connected to each other by said joints, and wherein said metal joint plates are embedded within said joints for reinforcing the connection between said stiles and rails.

17. A reinforced fire retardant panel door in accordance with claim 13, wherein said joints are tongue and groove joints.

18. A reinforced fire retardant panel door in accordance with claim 13, wherein said metal inserts are embedded within a core section of said door.

19. A reinforced fire retardant panel door in accordance with claim 18, wherein said metal joint plates are embedded within said core section of said door.

20. A reinforced fire retardant panel door in accordance with claim 19, wherein said core section is made from a fire resistant blocking material.

21. A reinforced fire retardant panel door in accordance with claim 20, wherein said core section in combination with said embedded metal inserts and said embedded metal joint plates increases the structural strength of said door in order to prevent buckling of said door during a fire.

22. A reinforced fire retardant panel door in accordance with claim 13, wherein said metal inserts are made from a metal material selected from the group consisting of steel, stainless steel alloys, tantalum, and titanium alloys.

23. A reinforced fire retardant panel door in accordance with claim 13, wherein said metal joint plates are made from a metal material selected from the group consisting of steel, stainless steel alloys, tantalum, and titanium alloys.
